(19) United States
(12) Patent Application Publication
(10) Pub. No.: US 2022/0219381 A1
(43) Pub. Date: Jul. 14, 2022

(54) BUILDING AN OBJECT WITH A THREE-DIMENSIONAL PRINTER USING VIBRATIONAL ENERGY

(71) Applicant: XEROX CORPORATION, Norwalk, CT (US)

(72) Inventors: Denis Cormier, Pittsford, NY (US); Santokh S. Badesha, Pittsford, NY (US); Varun Sambhy, Pittsford, NY (US)

(73) Assignee: XEROX CORPORATION, Norwalk, CT (US)

(21) Appl. No.: 17/144,910

(22) Filed: Jan. 8, 2021

(51) Int. Cl. B29C 64/112; B29C 64/209; B29C 64/295; B29C 64/245; B29C 64/273; B29C 64/232; B29C 64/236; B29C 64/241

(52) U.S. Cl. CPC B29C 64/112; B29C 64/209; B29C 64/295; B29C 64/245; B33Y 10/00; B29C 64/232; B29C 64/236; B29C 64/241; B29C 64/273

(57) ABSTRACT

A three-dimensional (3D) printer includes an ejector and a coil wrapped at least partially around the ejector. The 3D printer also includes a power source configured to transmit voltage pulses to the coil. The 3D printer includes a computing system causing one or more drops of the liquid to be jetted out of the nozzle, and a vibrational source configured to transmit vibrational energy towards the printing material. The frequency of the vibrational energy may be dynamically modulated as a 3D object is formed by the 3D printer, and may be directly or indirectly applied to the printing material or 3D object. The vibrational source may include a piezoelectric source, ultrasonic source, a focused acoustic energy source, a laser vibrational source, or combinations thereof.

### TECHNICAL FIELD

The present teachings relate generally to three-dimensional (3D) printing and, more particularly, to systems and methods for building (e.g., printing) an object with a 3D printer using vibrational energy.

### BACKGROUND

A 3D printer builds (e.g., prints) a 3D object from a computer-aided design (CAD) model, usually by successively depositing material layer upon layer. For example, a first layer may be deposited upon a substrate, and then a second layer may be deposited upon the first layer. One particular type of 3D printer is a magnetohydrodynamic (MHD) printer, which is suitable for jetting liquid metal layer upon layer to form a 3D metallic object. Magnetohydrodynamic refers to the study of the magnetic properties and the behavior of electrically conducting fluids.

An MHD printer causes an electrical current to flow through a metal coil, which produces time-varying magnetic fields that induce eddy currents within a reservoir of liquid metal compositions. Coupling between magnetic and electric fields within the liquid metal results in Lorentz forces that cause ejection of drops of the liquid metal through a nozzle of the printer. The nozzle may be controlled to select the size and shape of the drops. The drops land upon the substrate and/or the previously deposited drops to cause the object to grow in size. However, objects produced in this manner oftentimes have cold joints between deposited drops caused by incomplete drop coalescence due to inter-droplet surface tension which leads to insufficiencies in 3D object microstructures and mechanical properties.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A three-dimensional (3D) printer is disclosed. The 3D printer also includes an ejector having a nozzle, a coil wrapped at least partially around the ejector, and a power source configured to transmit voltage pulses to the coil and configured to supply one or more pulses of power to the coil, which causes one or more drops of a printing material to be jetted out of the nozzle. The 3D printer also includes a vibrational source configured to transmit vibrational energy towards the one or more drops of printing material.

In another embodiment, the 3D printer transmits vibrational energy having an amplitude that is less than or equal to 75% of a diameter of the one or more drops of printing material and a frequency that ranges from 100 Hz to 20 kHz and wherein the frequency of the vibrational energy may be dynamically modulated as a 3D object is formed by the 3D printer. The 3D printer may include a heating element configured to heat the printing material in the ejector, thereby causing the printing material to change from a solid state to a liquid state within the ejector, a substrate positioned below the nozzle and configured to receive the drops of the printing material after the drops of the printing material are jetted through the nozzle, and a substrate control motor configured to move the substrate after the drops of the printing material are jetted through the nozzle.

In another embodiment, the vibrational source may be directly or indirectly applied to the substrate. The vibrational energy may be directly applied to the substrate in a direction parallel to the substrate, in an oblique direction, in an orbital direction, intermittently or a combination thereof. The vibrational source may transmit vibrational energy towards the drops of the printing material after the substrate receives the drops of the printing material.

In another embodiment, the 3D printer includes a vibrational source that may be a piezoelectric source, ultrasonic source, a focused acoustic energy source, a laser vibrational source, or combinations thereof.

Also disclosed is a method for printing a three-dimensional (3D) object using a 3D printer. The method may include jetting a first plurality of drops of a printing material through a nozzle and directing a vibrational energy towards the first plurality of drops of printing material.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a 3D printer (e.g., a MHD printer and/or multi-jet printer), according to an embodiment.

FIG. 2 illustrates a schematic side view of a first example of the 3D object on the substrate, according to an embodiment.

FIG. 3 illustrates a photograph of the first example of the 3D object from FIG. 2, according to an embodiment.

FIG. 4 illustrates schematic side views of a second example of the 3D object on the substrate that is formed when the 3D printer operates with vibrational energy, according to an embodiment.

FIG. 5 illustrates a flowchart of a method for printing the object using the 3D printer, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

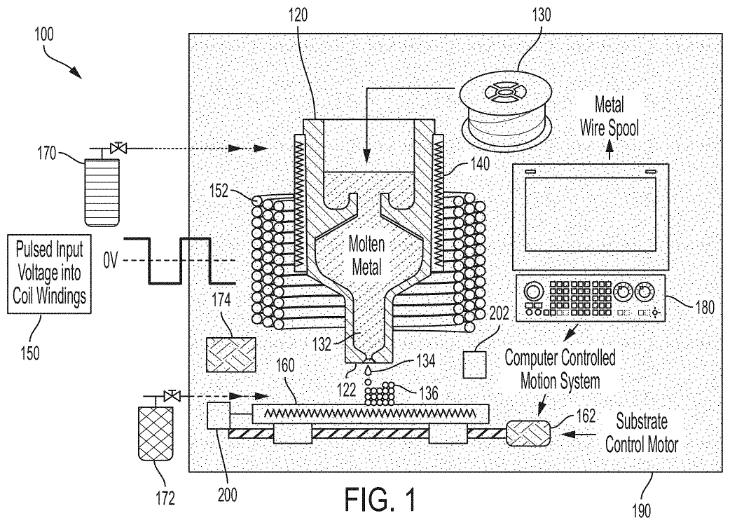

FIG. 1 depicts a schematic cross-sectional view of a 3D printer 100, according to an embodiment. The 3D printer 100 may include an ejector (also referred to as a body or pump chamber) 120. The ejector 120 may define an inner volume (also referred to as a cavity). A printing material 130 may be introduced into the inner volume of the ejector 120. The printing material 130 may be or include a metal, a polymer, composite, or the like. For example, the printing material 130 may be or include aluminum or aluminum alloy (e.g., a spool of aluminum wire).

The 3D printer 100 may also include one or more heating elements 140. The heating elements 140 are configured to melt the printing material 130, thereby converting the printing material 130 from a solid state to a liquid state (e.g., liquid metal 132) within the inner volume of the ejector 120.

The 3D printer 100 may also include a power source 150 and one or more metallic coils 152 that are wrapped at least partially around the ejector 120. The power source 150 may be coupled to the coils 152 and configured to provide an electrical current to the coils 152. In one embodiment, the power source 150 may be configured to provide a step function direct current (DC) voltage profile (e.g., voltage pulses) to the coils 152, which may create an increasing magnetic field. The increasing magnetic field may cause an electromotive force within the ejector 120, that in turn causes an induced electrical current in the liquid metal 132. The magnetic field and the induced electrical current in the liquid metal 132 may create a radially inward force on the liquid metal 132, known as a Lorenz force. The Lorenz force creates a pressure at an inlet of a nozzle 122 of the ejector 120. The pressure causes the liquid metal 132 to be jetted through the nozzle 122 in the form of one or more liquid drops 134.

The 3D printer 100 may also include a substrate 160 that is positioned proximate to (e.g., below) the nozzle 122. The drops 134 may land on the substrate 160 and solidify to produce a 3D object 136. In one example, the 3D object 136 may be or include a strut, which may be part of a lattice structure. A 3D object 136 may be considered to be comprised of one or more drops 134 of a printing material 130 jetted by the 3D printer 100.

The 3D printer 100 may also include a substrate control motor 162 that is configured to move the substrate 160 while the drops 134 are being jetted through the nozzle 122, or during pauses between when the drops 134 are being jetted through the nozzle 122, to cause the 3D object 136 to have the desired shape and size. The substrate control motor 162 may be configured to move the substrate 160 in one dimension (e.g., along an X axis), in two dimensions (e.g., along the X axis and a Y axis), or in three dimensions (e.g., along the X axis, the Y axis, and a Z axis). In another embodiment, the ejector 120 and/or the nozzle 122 may be also or instead be configured to move in one, two, or three dimensions. In other words, the substrate 160 may be moved under a stationary nozzle 122, or the nozzle 122 may be moved above a stationary substrate 160. In yet another embodiment, there may be relative rotation between the nozzle 122 and the substrate 160 around one or two additional axes, such that there is four or five axis position control.

The 3D printer 100 may also include one or more gas-controlling devices, which may be or include gas sources (two are shown: 170, 172). The first gas source 170 may be configured to introduce a first gas. The first gas may be or include an inert gas, such as helium, neon, argon, krypton, and/or xenon. In another embodiment, the first gas may be or include nitrogen. The first gas may include less than about 10% oxygen, less than about 5% oxygen, or less than about 1% oxygen.

In at least one embodiment, the first gas may be introduced at a location that is above where the second gas is introduced. For example, the first gas may be introduced at a location that is above the nozzle 122 and/or the coils 152. This may allow the first gas (e.g., argon) to form a shroud/sheath around the nozzle 122, the drops 134, the 3D object 136, and/or the substrate 160 to reduce/prevent the formation of oxide (e.g., aluminum oxide). Controlling the temperature of the first gas may also or instead help to control (e.g., minimize) the rate that the oxide formation.

The second gas source 172 may be configured to introduce a second gas. The second gas may be different than the first gas. The second gas may be or include oxygen, water vapor, carbon dioxide, nitrous oxide, ozone, methanol, ethanol, propanol, or a combination thereof. The second gas may include less than about 10% inert gas and/or nitrogen, less than about 5% inert gas and/or nitrogen, or less than about 1% inert gas and/or nitrogen. The second gas may be introduced at a location that is below the nozzle 122 and/or the coils 152. For example, the second gas may be introduced at a level that is between the nozzle 122 and the substrate 160. The second gas may be directed toward the nozzle 122, the falling drops 134, the 3D object 136, the substrate 160, or a combination thereof. This may help to control the properties (e.g., contact angle, flow, coalescence, and/or solidification) of the drops 134 and/or the 3D object 136.

The 3D printer 100 may also include another gas-controlling device, which may be or include a gas sensor 174. The gas sensor 174 may be configured to measure a concentration of the first gas, the second gas, or both. More particularly, the gas sensor 174 may be configured to measure the concentration proximate to the nozzle 122, the falling drops 134, the 3D object 136, the substrate 160, or a combination thereof. As used herein, “proximate to” refers to within about 10 cm, within about 5 cm, or within about 1 cm.

The 3D printer 100 may also include a computing system 180. The computing system 180 may be configured to control the printing of the 3D object 136. More particularly, the computing system 180 may be configured to control the introduction of the printing material 130 into the ejector 120, the heating elements 140, the power source 150, the substrate control motor 162, the first gas source 170, the second gas source 172, the gas sensor 174, or a combination thereof. As discussed in greater detail below, in one embodiment, the computing system 180 may control the rate at which the voltage pulses are provided from the power source 150 to the coils 152, and thus the corresponding rate at which the drops 134 are jetted through the nozzle 122. These two rates may be substantially the same.

In another embodiment, the computing system 180 may be configured to receive the measurements from the gas sensor 174, and also configured to control the first gas source 170 and/or the second gas source 172, based at least partially upon the measurements from the gas sensor 174, to obtain the desired gas concentration around the drops 134 and/or the object 136. In at least one embodiment, the concentration of the first gas (e.g., nitrogen) may be maintained between about 65% and about 99.999%, between about 65% and about 75%, between about 75% and about 85%, between about 85% and about 95%, or between about 95% and about 99.999%. In at least one embodiment, the concentration of the second gas (e.g., oxygen) may be maintained between about 0.000006% and about 35%, between about 0.000006% and about 0.00001%, between about 0.00001% and about 0.0001%, between about 0.0001% and about 0.001%, between about 0.001% and about 0.01%, between about 0.01% and about 0.1%, between about 0.1% and about 1%, between about 1% and about 10%, or between about 10% and about 35%.

The 3D printer 100 may also include an enclosure 190 that defines an inner volume (also referred to as an atmosphere). In one embodiment, the enclosure 110 may be hermetically sealed. In another embodiment, the enclosure 110 may not be hermetically sealed. In one embodiment, the ejector 120, the heating elements 140, the power source 150, the coils 152, the substrate 160, the computing system 170, the first gas source 180, the second gas source 182, the gas sensor 184, or a combination thereof may be positioned at least partially within the enclosure 190. In another embodiment, the ejector 120, the heating elements 140, the power source 150, the coils 152, the substrate 160, the computing system 170, the first gas source 180, the second gas source 182, the gas sensor 184, or a combination thereof may be positioned at least partially outside of the enclosure 190.

The 3D printer 100 may also include an integrated vibrational energy source 200 coupled to the substrate 160, which introduces vibrational energy to drops 134 of the printing material 130 forming the 3D object 136 after the drops 134 are ejected from the nozzle 122 and after the drops 134 land onto the substrate 160. In one embodiment, the integrated vibrational energy source 200 is mechanically coupled to the substrate 160 and introduces a vibrational energy prior to one or more drops 134 landing on the substrate 160. In one embodiment, the integrated vibrational energy source 200 introduces a vibrational energy to the substrate 160 as the drops 134 land on the substrate 160, In one embodiment, the integrated vibrational energy source 200 introduces a vibrational energy to the substrate 160 prior to one or more drops 134 landing on the substrate 160, while the drops 134 are solidifying, or after multiple drops 134 land on the substrate 160, or combinations thereof. The integrated vibrational energy source 200 may have an internal control system. In some embodiments, the integrated vibrational energy source 200 may be independently controlled with the substrate control motor 162, the computing system 180, or a combination thereof. In one embodiment, the computing system 180 may interface with and directly control the internal control system of the integrated vibrational energy source 200. Examples of integrated, contacting, or coupled vibrational energy sources include eccentric rotating mass vibration motors (ERM), electromagnetic-driven vibration motors, contacting ultrasonic vibrational sources, piezoelectric vibrational sources, a vibration platform coupled to the substrate 160, and combinations thereof.

The 3D printer 100 may also include an external non-contact vibrational energy source 202, which is directed towards and subjects drops 134 of the printing material 130 to vibrational energy after the drops 134 are ejected from the nozzle 122. In one embodiment, the non-contact vibrational energy source 202 is aimed at a location between the nozzle 122 and the substrate 160 and the vibrational energy is directed towards drops 134 of the printing material 130 before the drops 134 land on the substrate 160. In another embodiment having an external vibrational energy source 202, the external vibrational energy source 202 is aimed at a location on the substrate 160 and the vibrational energy is directed towards drops 134 of the printing material 130 after the drops 134 land on the substrate 160, forming a 3D object 136. The non-contact vibrational energy source 202 may have an internal control system. In some embodiments, the non-contact vibrational energy source 202 may be independently controlled with the substrate control motor 162, the computing system 180, or a combination thereof. In one embodiment, the computing system 180 may interface with and directly control the internal control system of the non-contact vibrational energy source 202. In one embodiment, there may be multiple external vibrational energy sources that introduce vibrational energy to drops 134 of printing material 130 before and after the drops 134 are deposited onto the substrate 160. Examples of external non-contact vibrational energy sources include laser doppler vibrometer (LDV), vibrational photo acoustic (VPA) sources, focused sound waves utilizing an acoustic lens, non-contact ultrasonic vibration sources, and combinations thereof. Focused or unfocused acoustic sound or acoustic vibrational energy sources of any type may have a frequency from about 40 Hz to about 20 KHz. Focused or unfocused ultrasonic vibrational energy sources of any type may have a frequency from about 8 kHz to about 24 KHz.

In one embodiment, the vibrational source may be powered on or operational in a consistent or continuous manner during jetting. Alternatively, in an embodiment, the vibrational source may be intermittently powered on or operational in a non-continuous manner during jetting. In one embodiment, vibrational energy may be applied with the 3D printer parallel to a plane defined by the substrate 160 in an oscillating or back-and-forth manner. Alternatively, the motion of the vibrational energy source may be orbital or elliptical yet parallel with respect to a plane defined by the substrate 160 or directed in such a way that the contact vibrational energy source is specifically directed towards a localized area on the substrate 160 where the droplets of printing material 130 are cooling or solidifying.

The vibrational energy may be applied, in one embodiment, in a direction perpendicular to a plane defined by the substrate 160, or in an oblique direction compared to a plane defined by the substrate 160. In an embodiment utilizing a non-contact or external vibrational energy source, the vibrational energy may be focused, with either an adjustable focus or a fixed focus, the focus being directed at drops of printing material 130 on the substrate 160 or towards the substrate 160 in proximity to drops of printing material 130. Alternatively, in an embodiment, the non-contact vibrational energy source may be non-focused. In some embodiments, combinations of one or more of the contacting, non-contacting or directional applications or directional motions as described herein may be used.

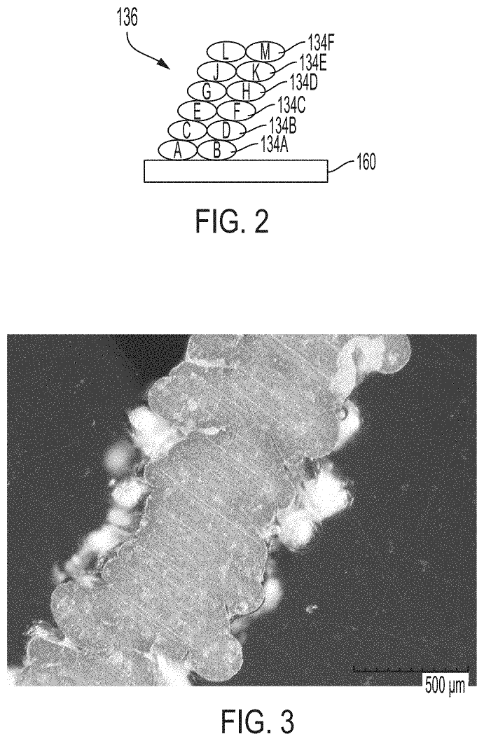

FIG. 2 illustrates a schematic side view of a first example of the 3D object 136 on the substrate 160 that is formed when the 3D printer 100 operates without the introduction of vibrational energy, according to an embodiment. To form the 3D object 136, the power source 150 may transmit a plurality of voltage pulses to the coils 152, which may cause a corresponding plurality of drops (twelve are shown: 134A-134M, note that 1341 is skipped to avoid confusion with the number 1341) to jet through the nozzle 122. The drops, 134A-134M, may be jetted at a predetermined frequency and allows each drop for example (e.g. drop 134A) to begin cooling before the next drop (e.g. drop 134B) is jetted through the nozzle 122 and deposited onto the previous drop or the substrate 160. The predetermined frequency may be from about 10 Hz to about 1000 Hz, which may cause from about 10 drops to about 1000 drops to be jetted through the nozzle 122 per second. Forming the 3D object 136 in this manner may also cause the 3D object 136 to have internal micro voids, cold weld joints between drops, or other structural defects, such as a bumpy (not smooth) surface morphology, as shown in FIG. 3.

In the embodiment shown, the first layer 135A of drops may be deposited onto the substrate 160, the second layer 135B of drops may be deposited onto the first layer, and so on with respect to successive layers of drops (135C-135F). Each drop (e.g., drop 134B) is horizontally offset from the previously jetted drop (e.g., drop 134A) by less than a width of the previously jetted drop (e.g., drop 134A). In the embodiment shown, the resulting diameter of drops 134A-134M may be from about 0.05 mm to about 1 mm, from about 0.1 mm to about 0.5 mm, or from about 0.25 mm to about 0.5 mm. Other embodiments may result in drops having a diameter larger or smaller than those mentioned herein. While the drops (134A-134M) shown in each of the respective layers 135A-135F, in FIG. 2 are shown in proximity to one another, they may not be completely coalesced and they may not form a cohesive and completely welded structure with respect to the boundary layers between each of the individual drops (134A-134M). This incomplete melding of neighboring drops may cause the 3D object 136 to be bumpy (e.g., not smooth), as shown in FIG. 3.

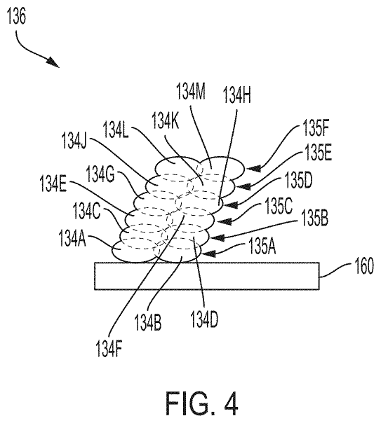

FIG. 4 illustrates a schematic side view of a second example of the 3D object 136 on the substrate 160 that is formed when the 3D printer 100 operates with the introduction of vibrational energy, according to an embodiment. To form the 3D object 136 according to one embodiment, the power source 150 may transmit a plurality of voltage pulses to the coils 152, similarly as to the process described in regard to FIGS. 2 and 3. According to one embodiment, as shown in FIG. 4, when the drops 134A-134M are subjected to vibrational energy after they land onto the substrate 160, the surface tension of the outer layer of each drop may be disrupted by vibrational energy. As used herein, vibrational energy refers to energy that is directed towards a jetted drop prior to landing onto a substrate 160 and/or after a jetted drop lands onto a substrate 160. As discussed in greater detail below, the vibration frequency and vibration amplitude at which the vibrational energy is applied to the drop or drops, is sufficient to disrupt the surface tension of the outer layer of each drop, yet below a threshold value that would distort or otherwise compromise the overall structure of a formed 3D object 136.

As shown in FIG. 4, a first plurality of drops (two are shown: 134A-134B) may be jetted through the nozzle 122 to form a first layer 135A on the substrate 160. The first plurality of drops 134A-134B may be jetted at a frequency that substantially allows each drop (e.g., drop 134A) in a particular layer (e.g., layer 135A) or adjacent to one another to cool and solidify before the next drop (e.g., drop 134B) in that layer 135A is jetted through the nozzle 122 and/or deposited on the previous drop (e.g., drop 134A). In certain embodiments, a droplet may land on and/or overlap a previously jetted droplet before it has cooled enough to begin solidification. While rate of jetting and cooling of the drops is one mechanism that contributes to the coalescence of adjacent drops or layers, the surface tension formed when a drops lands may also be a contributing factor. Thus, the introduction of vibrational energy towards the substrate 160 in one embodiment may disrupt the surface tension between adjacent cooling drops or layers to allow the second drop 134B to contact and/or at least partially combine with the first drop 134A while the first drop 134A is still partially or fully in a liquid state. As a result, the drops 134A-134B may form a puddle of liquid metal, which may subsequently solidify to form the first layer 135A.

The vibrational energy applied to the substrate 160 may be characterized as having a vibrational frequency, or number of cycles that a vibrating object completes in one second, in a subsonic range, or less than 20 Hz, a sonic range, or from about 20 Hz to about 20,000 Hz, or in an ultrasonic range, or from about 8 kHz to greater than 20 kHz. In some embodiments, the vibrational energy may operate in a frequency that may be proportional to the mass of a 3D object 136 formed by the 3D printer. Furthermore, the frequency may be dynamically modulated or adjusted as the mass of the 3D object 136 changes during material printing. While dependent on the inherent properties of the printing material, the resonant frequencies of a part and an associated build plate may change as the amount of material and resulting mass of the printed object increase during the printing of a 3D object. Thus, the frequency of vibration in some embodiments may be dynamically changed during printing to target a dynamically changing resonant frequency of a 3D object as it is printed.

The vibration amplitude, intensity, or distance from the stationary position to the extreme position on either side of a vibration oscillation cycle, applied to the substrate 160 may be from about 0.001 mm to about 0.75 mm, from about 0.01 mm to about 0.40 mm, or from about 0.15 mm to about 0.4 mm. In some embodiments, the vibrational energy may have an amplitude that is less than or equal to 75% of a diameter of the one or more drops 134 of printing material 130.

The vibration frequency, vibration amplitude, and oscillation may be selected/varied based at least partially upon the volume and/or mass of each drop 134A-134B. In addition to drop size and 3D object 136 mass, frequency and amplitude selection may also be influenced by the printing material 130, inherent resonance of the printing material 130, or temperature in certain embodiments. The vibration energy may be directed towards the drops 134 or the 3D printed object in a direction that may be perpendicular, parallel, at an angle relative to the substrate 160 or 3D object 136, or combinations thereof when multiple vibrational sources are used in particular embodiments.

After the first layer 135A is jetted, the 3D printer 100 may then jet a second layer 135B of drops (two additional drops are shown: 134C-134D) onto the first layer 135A. The second layer 135B of drops 134C-134D may be jetted in concert with a vibrational energy to disrupt the surface tension of each drop and assist the liquid to spread out and merge with surrounding printing material to avoid the formation of voids or pores in the printed material. prevent each drop (e.g., drop 134C) in a particular layer (e.g., layer 135B) from cooling and solidifying before the next drop (e.g., drop 134D) in that layer 135B is jetted through the nozzle 122 and/or deposited on the previous drop (e.g., drop 134C). This may allow the second drop 134D to contact and/or at least partially combine with the first drop 134C while the first drop 134C is still partially or fully in a liquid state. As a result, the drops 134C-134D may form a puddle of liquid metal, which may subsequently solidify to form the second layer 135B.

The second layer 135B of drops 134C-134D may at least partially re-melt the previously deposited layer (e.g., layer 135A). For example, the second layer 135B of drops 134C-134D may have enough heat to at least partially re-melt and combine with an upper portion (e.g., the top surface) 138 of the previously deposited layer 135A without causing the 3D object 136 to slump over or otherwise distort from the desired shape and/or angle. Vibrational energy applied to either the drops 134A-134D or 3D object 136 via coupling to the substrate 160 or an external vibration energy source may provide disruption of the interfacial surface tension of the drops 134A-134D or the upper portion 138 such that the vibrational energy interferes with the crystallization and solidification of the first deposited layer 135A or second deposited layer 135B. After the second layer of drops 134C-134D has been jetted, the process may repeat to form a plurality of additional layers 135C-135G, as shown in FIG. 4.

In one embodiment, as one or more drops 134 solidify during the printing of a 3D object 136, surface tension of a drop, drop surface oxidation, surface cooling, or combinations thereof can result in cold weld joints or incomplete drop coalescence between drops 134 leading to incomplete melting and flowing between drops 134 or between sets of drops 134. Printed articles as described in regard to FIGS. 2 and 3 may have decreased density, reduced physical properties, and microstructural voids or deformities. Vibrational energy introduced into these printed articles during or after drop deposition as described in FIG. 4 may effectively interfere with the crystallization process during solidification. The application of vibratory energy during solidification of the melted printing material reduces the amount and size of pores, and reduces the columnar microstructure by disrupting nucleation and growth of long grains during solidification. Vibrational energy may also have an advantageous influence on providing vibration-driven wetting or disrupting inter-drop surface tension, thereby reducing or minimizing barriers to drop coalescence during solidification and/or cooling of neighboring drops 134 forming a 3D object 136. In the embodiment shown, continuous vibrational energy may be applied to the printer 100 for the duration of jetting, solidification, subsequent layer formation, and substrate motion operations occurring during the operation of the 3D printer 100. Alternatively, in one embodiment, intermittent vibrational energy is applied non-continuously during jetting, solidification, layer formation, and substrate motion during the operation of the 3D printer 100. Forming the 3D object 136 using added vibrational energy may cause the 3D object 136 to be substantially smooth, which may improve the mechanical properties of the 3D object 136.

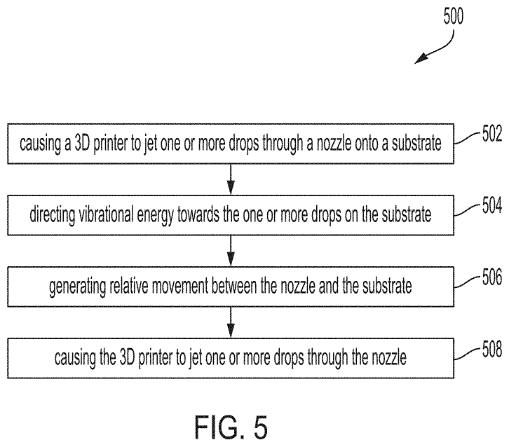

FIG. 5 illustrates a flowchart of a method 500 for printing the 3D object 136 using the 3D printer 100, according to an embodiment. An illustrative order of the method 500 is provided below. One or more steps of the method 500 may be performed in a different order, performed simultaneously, repeated, or omitted.

The method 500 may include jetting one or more drops such as 134A-134B, as at 502. This may include the computing system 180 causing the power source 170 to transmit a first number of voltage pulses to the coils 152. In response, the coils 152 may cause the first jetting of one or more drops 134A-134B to be jetted through the nozzle 122. The first burst of drops 134A-134C may be deposited onto the substrate 160. The nozzle 122 and/or the substrate 160 may be/remain substantially stationary (e.g., with respect to one another) during step 502. As mentioned above, each of the drops 134A-134B may be deposited before the other drops 134A-134B in that particular layer 135A fully solidify. For example, the first drop 134A may have a solid volume fraction that is less than about 90%, less than about 70%, less than about 50%, or less than about 30% before the second drop 134B lands on the first drop 134A. If the first drop 134A has a solid volume fraction of 90%, this means that the first drop 134A is 90% solid and 10% liquid.

The method 500 may also include directing vibrational energy towards drops 134A-134B, towards the 3D object 136, or towards the substrate 160, as at 504. Step 504 may be performed after step 502. This step may include the computing system 180 causing the coupled vibrational energy source 200, for example, a piezoelectric vibration source, to engage to introduce vibrational energy towards the substrate 160. In response, the substrate 160 may transmit the vibrational energy to the drops 134A-134B and/or towards the 3D object 136. The first layer 135A of drops 134A-134B may cool and at least partially (or fully) solidify as the vibrational energy is applied. Step 502 may include continuous or intermittent vibrational energy. In some embodiments, the vibrational energy transmitted may have an amplitude equal to or less than 75% of a diameter of each drop 134 and a frequency that may be dynamically modulated or adjusted as the mass of the 3D object 136 increases during material printing. An example embodiment may alternatively include eccentric rotating mass vibration motors (ERM), electromagnetic-driven vibration motors, contacting ultrasonic vibrational sources, a vibration platform coupled to the substrate 160, and combinations thereof.

The method 500 may also include generating relative movement between the nozzle 122 and the substrate 160, as at 506. Step 506 may be performed before, simultaneously with, or after step 502 and/or 504. This step may include the computing system 180 causing the substrate control motor 162 to move the substrate 160 in one or more dimensions so that the drops 134C-134D land in the desired location(s) to form the 3D object 136. In one example, a (e.g., vertical) distance between the nozzle 122 and the substrate 160 may be increased. In another example, lateral (e.g., horizontal) movement between the nozzle 122 and the substrate 160 may be introduced so that the layers 135A, 135B are laterally offset from one another but at least partially overlapping. In yet another example, step 506 may be omitted.

The method 500 may include jetting the second layer 135B having one or more drops 134C-134D, as at 508. Step 508 may be performed before, simultaneously with, or after step 506. This step may include the computing system 180 causing the power source 170 to transmit voltage pulses to the coils 152. In response, the coils 152 may cause the second layer 135B having one or more drops 134C-134D to be jetted through the nozzle 122. The second layer 135B having one or more drops 134C-134D may be deposited onto the substrate 160 and/or onto the first layer of drops 134A-134B (e.g., the first layer 135A), as shown in FIG. 4. The nozzle 122 and/or the substrate 160 may be/remain substantially stationary (e.g., with respect to one another) during step 508. As mentioned above, each of the drops 134C-134D may be deposited before the other drops 134C-134D in that particular layer 135B fully solidify. In one embodiment, the method 500 may loop back around to step 504 and repeat or continue directing vibrational energy towards the one or more drops on the substrate to form additional layers 135C-135G of the 3D object 136.

The method 500 may also include directing vibrational energy towards the one or more drops on the substrate from an external vibrational source 202. This external vibrational energy source 202, or non-contact vibrational energy source is not directly coupled to the substrate 160 but directs vibrational energy at or near the one or more drops 134 or the 3D object on the substrate 160 to influence the breaking of surface tension between drops 134 as they solidify during the printing of a 3D object 136. This optional step may be performed before, simultaneously with, or after step 502, 504, 506, 508, or a combination thereof. This step may include continuous or intermittent vibrational energy. In some embodiments, the vibrational energy transmitted may have an amplitude equal to or less than 75% of a diameter of each drop 134 and a frequency that may be dynamically changed as a 3D object is printed, based on the mass or resonant frequency of the 3D object. In an example embodiment, this step may include a non-contacting vibrational energy source, such as laser doppler vibrometer (LDV), vibrational photo acoustic (VPA) sources, non-contact ultrasonic vibration sources, or combinations thereof. In another example embodiment, this step may include both contacting and non-contacting methods of vibrational energy sources.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” may include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A three-dimensional (3D) printer, comprising:
an ejector comprising a nozzle;
a coil wrapped at least partially around the ejector;
a power source configured to transmit voltage pulses to the coil and configured to supply one or more pulses of power to the coil, which causes one or more drops of a printing material to be jetted out of the nozzle; and
a vibrational source configured to transmit vibrational energy towards the one or more drops of printing material.

2. The 3D printer of claim 1, wherein the vibrational energy has an amplitude that is less than or equal to 75% of a diameter of the one or more drops of printing material.

3. The 3D printer of claim 1, wherein the vibrational energy has a frequency that ranges from 100 Hz to 20 kHz.

4. The 3D printer of claim 1, wherein the vibrational energy has a frequency that is dynamically modulated as a 3D object is formed by the 3D printer.

5. The 3D printer of claim 1, further comprising:
a heating element configured to heat the printing material in the ejector, thereby causing the printing material to change from a solid state to a liquid state within the ejector;
a substrate positioned below the nozzle and configured to receive the drops of the printing material after the drops of the printing material are jetted through the nozzle; and
a substrate control motor configured to move the substrate after the drops of the printing material are jetted through the nozzle.

6. The 3D printer of claim 5, wherein the vibrational source is directly applied to the substrate.

7. The 3D printer of claim 5, wherein the vibrational energy is directly applied to the substrate in a direction parallel to the substrate.

8. The 3D printer of claim 7, wherein the vibrational energy is directly applied to the substrate in an orbital direction.

9. The 3D printer of claim 5, wherein the vibrational source transmits vibrational energy intermittently.

10. The 3D printer of claim 5, wherein the vibrational source transmits vibrational energy towards the drops of the printing material after the substrate receives the drops of the printing material.

11. The 3D printer of claim 5, wherein the vibrational energy is applied to the substrate in a direction oblique to the substrate.

12. The 3D printer of claim 1, the vibrational source further comprising a piezoelectric source.

13. The 3D printer of claim 1, the vibrational source further comprising an ultrasonic source.

14. The 3D printer of claim 1, the vibrational source further comprising a focused acoustic energy source.

15. The 3D printer of claim 1, the vibrational source further comprising a laser vibrational source.

16. The 3D printer of claim 1, wherein the printing material comprises metal, metallic alloys, or a combination thereof.

17. The 3D printer of claim 16, wherein the printing material comprises aluminum, aluminum alloys, or a combination thereof.

18. A three-dimensional (3D) printer, comprising:
an ejector comprising a nozzle;
a coil wrapped at least partially around the ejector;
a power source configured to transmit voltage pulses to the coil and configured to supply one or more pulses of power to the coil, which causes one or more drops of a printing material to be jetted out of the nozzle;
a heating element configured to heat the printing material in the ejector, thereby causing the printing material to change from a solid state to a liquid state within the ejector;
a substrate positioned below the nozzle and configured to receive the drops of the printing material after the drops of the printing material are jetted through the nozzle;
a substrate control motor configured to move the substrate after the drops of the printing material are jetted through the nozzle; and
a vibrational source coupled to the substrate and configured to transmit vibrational energy towards the one or more drops of printing material.

19. The 3D printer of claim 18, wherein the vibrational energy has an amplitude that is less than or equal to 75% of a diameter of the one or more drops of printing material.

20. The 3D printer of claim 18, wherein the vibrational energy has a frequency that is dynamically modulated as a 3D object is formed by the 3D printer.

21. A method for printing a three-dimensional (3D) object using a 3D printer, the method comprising:
jetting a first plurality of drops of a printing material through a nozzle; and
directing a vibrational energy towards the first plurality of drops of printing material, wherein the vibrational energy has an amplitude less than 75% of a diameter of each drop of printing material.

22. The method of claim 21, the method further comprising generating the vibrational energy with a piezoelectric source.
